(19) United States
(12) Patent Application Publication
(10) Pub. No.: US 2008/0026630 A1
(43) Pub. Date: Jan. 31, 2008

(54) Connector

(75) Inventors: Chih-Tse Chen, Taoyuan Hsien (TW); Chen-Jung Chen, Taoyuan Hsien (TW); Chin-Tse Wu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/822,247

(22) Filed: Jul. 3, 2007

(30) Foreign Application Priority Data
Jul. 28, 2006 (TW) 095127655

(51) Int. Cl. H01R 13/625

(52) U.S. Cl. 439/344

(57) ABSTRACT

A connector includes a body and a housing. The body includes a plurality of terminals and a first fastener. The terminals and the first fastener are disposed at different surface of the body. The housing covers at least one portion of the body and has a second fastener connected with the first fastener.

### CROSS REFERENCE TO RELATED APPLICATIONS

This Non-provisional application claims priority under 35 U.S.C. §119(a) on Patent Application No(s). 095127655 filed in Taiwan, Republic of China on Jul. 28, 2006, the entire contents of which are hereby incorporated by reference.

### BACKGROUND OF THE INVENTION

1. Field of Invention

The invention relates to a connector and in particular, to a connector capable of preventing interference of transmitted signals.

2. Related Art

Computer systems are now widely used because of the rapid developments of information science. Moreover, Internet has also been well developed, so that the users can get various information services by the combination of computer systems and Internet. Thus, the computer systems or periphery apparatuses with network connecting functions are the basic requirement in this information generation.

In general, connectors are used to connect the computer system to network or other electronic apparatuses. As shown in FIG. 1, a conventional RJ connector 1 includes an RJ jack 10 and a metal housing 20. The RJ jack 10 is for coupling with an RJ plug of a connecting wire. One end of the RJ jack 10 is embedded with a plurality of pads 11, and a plurality of terminals 12 protrude from the bottom of the RJ jack 10. Each pad 11 is electrically connected with the corresponding terminal 12. Therefore, if the RJ connector 1 is installed on an electronic apparatus and the RJ jack 10 is coupled with an RJ plug, the electronic apparatus can transmit or receive Internet signals through the pads 11 and terminals 12.

In addition, the RJ jack 10 is disposed in the metal housing 20 so as to protect the RJ jack 10 from electromagnetic interference (EMI). To assemble the RJ jack 10 with the metal housing 20, the RJ jack 10 is firstly inserted into the housing 20, and then a hooking member 21 of the housing 20 is used to fasten the bottom of the RJ jack 10 from which the terminals protrude. However, since the hooking member 21 is very close to some terminals 12, the electronic properties of the RJ connector 1 may be interfered by the hooking member 21, which may result in poor signal transmission of the electronic apparatus.

Therefore, it is an important subject to provide a connector with good electronic properties and capable of preventing interference of transmitted signals.

### SUMMARY OF THE INVENTION

In view of the foregoing, the invention is to provide a connector with good electronic properties for preventing interference of transmitted signals.

To achieve the above, the invention discloses a connector includes a body and a housing. The body includes a plurality of terminals and a first fastener, which are disposed on different surfaces of the body. The housing covers at least one portion of the body and includes a second fastener connecting with the first fastener.

As mentioned above, the connector of the invention has a first fastener disposed on a surface different from the surface formed with the terminals. Therefore, when the first and second fasteners are combined for fastening the body in the housing, the fasteners and the terminals are located at different surfaces. Thus, the first fastener of the body and the second fastener of the housing depart from the terminals with a certain distance so as to preventing the connecter from interference. So, the electronic properties of the connector will not be affected. Compared with the prior art, the design of the fasteners in the invention can make the connector having good electronic properties and stable signal transmission.

### BRIEF DESCRIPTION OF THE DRAWINGS

The invention will become more fully understood from the detailed description given herein below illustration only, and thus is not limitative of the present invention, and wherein:

FIG. 1 is a schematic view showing a conventional connector; and

FIGS. 2 and 3 are schematic views showing a connector according to an embodiment of the invention.

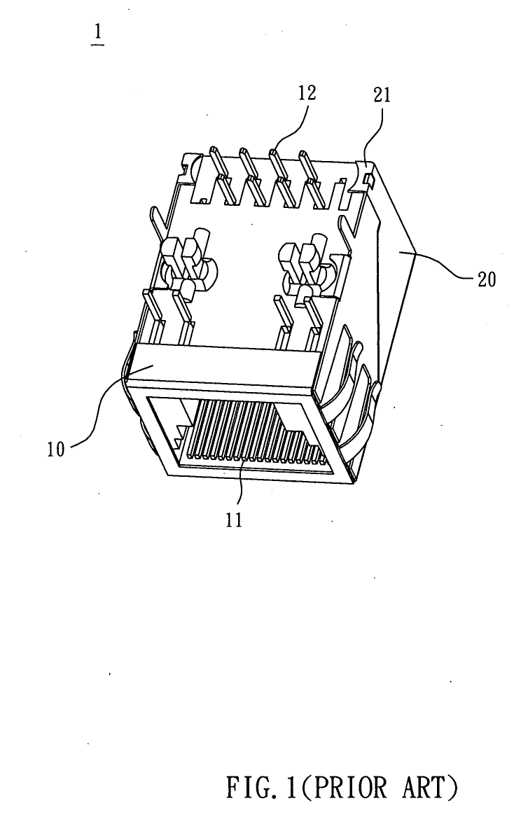

### DETAILED DESCRIPTION OF THE INVENTION

The present invention will be apparent from the following detailed description, which proceeds with reference to the accompanying drawings, wherein the same references relate to the same elements.

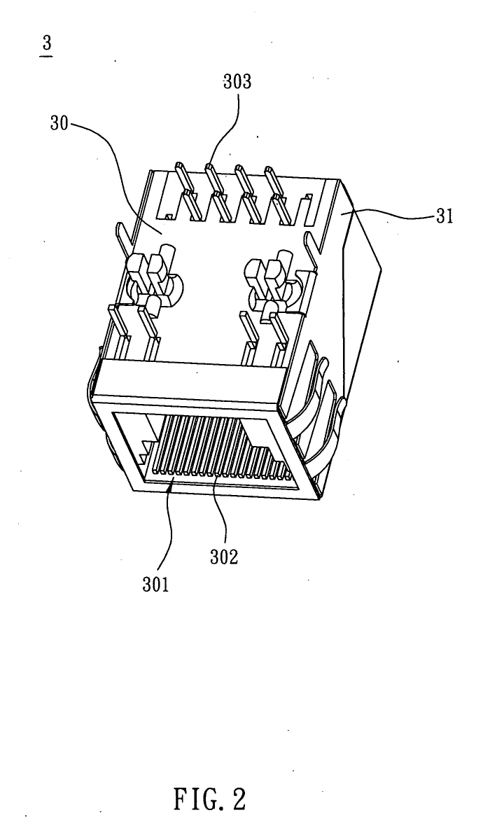

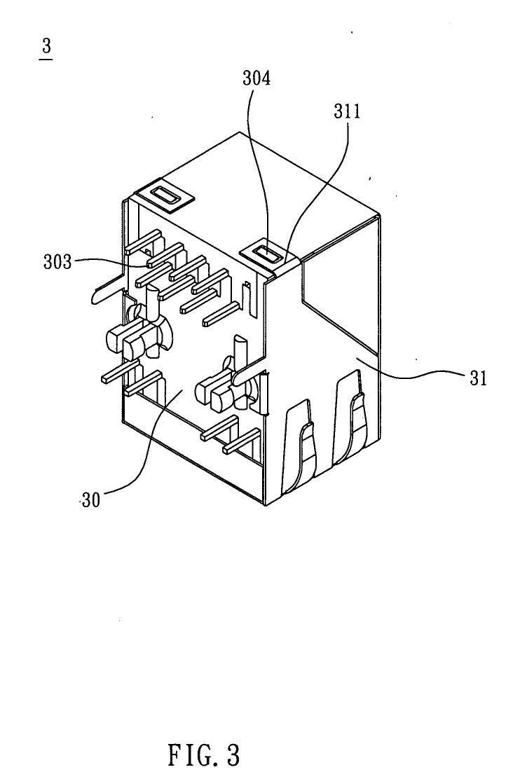

With reference to FIGS. 2 and 3, a connector 3 according to an embodiment of the invention includes a body 30 and a housing 31. The body 30 has a slot 301, a plurality of pads 302, a plurality of terminals 303 and a first fastener 304. The slot 301 is located at the front end of the body 30, and the pads 302 are disposed in the slot 301. The slot 301 and the pads 302 are used to couple with a plug, such as an RJ-11 plug, an RJ-12 plug, an RJ-45 plug or a USB plug. Of course the plug can further connect with a transmission wire. The terminals 303 are disposed at the bottom of the body 30 and are used for electrically connecting with external circuits. The first fastener 304 is disposed on a surface of the body 30, which differs from the bottom of the body 30 formed with the terminals 303. For example, the first fastener 304 is disposed on the back side of the body 30 as shown in FIG. 3, or on the side surface of the body 30 (not shown). In the embodiment, the first fastener 304 is formed with the body 30 as a monolithic piece. The first fastener 304 can be a protrusion or a recess, which is triangular, rectangular, trapezoid, arc-shaped, polygonal or irregular. The slot 301, pads 303 and first fastener 304 are preferably disposed on different surfaces of the body 30.

The housing 31 covers at least one portion of the body 30 and includes a second fastener 311 connecting with the first fastener 304 correspondingly. In the embodiment, the second fastener 311 includes a lock member or a hook to engage with the protrusion or recess of the first fastener 304 so as to combine the body 30 and housing 31. The second fastener 311 can be formed with the housing 31 as a monolithic piece. That is, the lock member or the hook is formed by deforming a portion of the housing 31. For example, the lock member or the hook can be formed by bending a portion of the housing 31. In the embodiment, the housing 31 is made of metal or alloy for protecting the body 30 and preventing EML In addition, the housing 31 preferably covers all surfaces of the body 30, and some of the surfaces of the body 30 are partially covered by the housing 31. In particular, portions of the surfaces near the terminals 303 are uncovered by the housing 31. The housing 31 is telescoped onto the body 30 a side having the slot 301, and covers around the slot 301.

In summary, the connector of the invention has a first fastener disposed on a surface different from the surface formed with the terminals. Therefore, when the first and second fasteners are connected for fastening the body in the housing, the fasteners and the terminals are located at different surfaces. Thus, the first and second fasteners depart from the terminals with a certain distance so as to preventing the connecter from interference. So, the electronic properties of the connector will not be affected. Compared with the prior art, the design of the fasteners in the invention can make the connector having good electronic properties and stable signal transmission.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A connector comprising:
a body having a slot, a plurality of terminals and a first fastener, wherein the terminals and the first fastener are disposed on different surfaces of the body; and
a housing covering at least one portion of the body and having a second fastener connecting with the first fastener.

2. The connector according to claim 1, wherein the terminals are disposed at a bottom of the body, and the first fastener is disposed on a back side of the body.

3. The connector according to claim 1, wherein the terminals are disposed at a bottom of the body, and the first fastener is disposed on a side of the body.

4. The connector according to claim 1, wherein the first fastener comprises a protrusion or a recess.

5. The connector according to claim 4, wherein a cross-section of the protrusion or the recess is triangular, rectangular, trapezoid, arc-shaped, polygonal or irregular.

6. The connector according to claim 4, wherein the second fastener comprises a lock member for locking with the protrusion or the recess.

7. The connector according to claim 4, wherein the second fastener comprises a hook to engage with the protrusion or the recess.

8. The connector according to claim 1, wherein the first fastener is formed with the body as a monolithic piece.

9. The connector according to claim 1, wherein the second fastener is formed with the housing as a monolithic piece.

10. The connector according to claim 1, wherein the second fastener is formed by deforming a part of the housing.

11. The connector according to claim 1, wherein the second fastener is formed by bending a part of the housing.

12. The connector according to claim 1, wherein the housing is made of metal or alloy.

13. The connector according to claim 1, wherein the connector is an RJ-11 connector, an RJ-12 connector, an RJ45 connector or a USB connector.

14. The connector according to claim 1, wherein the housing covers all surfaces of the body.

15. The connector according to claim 1, wherein some of the surfaces of the body are partially covered by the housing.

16. The connector according to claim 1, wherein a surface of the body near the terminals is uncovered by the housing.

17. The connector according to claim 1, wherein the housing is telescoped onto the body from a side having the slot of the body.
